(19) United States
(12) Patent Application Publication
(10) Pub. No.: US 2007/0087303 A1
(43) Pub. Date: Apr. 19, 2007

(54) Dental handpiece

(76) Inventors: Tom Papanek, Lake Forest, IL (US); Eugene J. Novak, Deerfield, IL (US); Thomas Edward Barker, Rockford, IL (US)

Correspondence Address: DENTSPLY INTERNATIONAL INC, 570 WEST COLLEGE AVENUE, YORK, PA, 17404, US

(21) Appl. No.: 11/401,770

(22) Filed: Apr. 11, 2006

Related U.S. Application Data
(63) Continuation-in-part of application No. 11/117,589, filed on Apr. 28, 2005, now abandoned.
Application No. 11/117,589 is a continuation of application No. 10/137,999, filed on May 3, 2002, now abandoned.
Application No. 10/137,999 is a continuation of application No. 10/082,589, filed on Feb. 25, 2002, now abandoned.
Application No. 10/082,589 is a continuation of application No. 10/017,023, filed on Dec. 14, 2001, now abandoned.
(60) Provisional application No. 60/256,579, filed on Dec. 18, 2000.

(51) Int. Cl. A61C 1/10

(52) U.S. Cl. 433/114

(57) ABSTRACT

A dental handpiece (10) of the type having a body (11), a head (13) and a neck (12), is improved by having at least one portion of the handpiece (10) formed by metal injection molding or MIM. The use of MIM allows for improved fabrication and function. According to one aspect of the invention, the head (13) and neck (12) of the handpiece (10) are MIM-formed as a single or unitary piece.

### RELATED APPLICATIONS

This application is a Continuation in Part of pending U.S. patent application Ser. No. 11/117,589 which is a continuation of U.S. Ser. No. 10/137,999 (Case MID-30C 2CON) filed May 3, 2002, which is a Continuation application of pending U.S. continuation patent application Ser. No. 10/082,589 (Case MID-30C CON) filed Feb. 25, 2001, which is a continuation application of pending U.S. patent application Ser. No. 10/017,023 (Case MID-30C) filed Dec. 14, 2001, which claims the benefit from Provisional Application No. 60/056,579 filed Dec. 18, 2000.

### TECHNICAL FIELD

The present invention is a dental handpiece, or a portion thereof. More particularly, the invention relates to a dental handpiece, wherein a portion such as the head, neck or body, is fabricated from a metal, such as stainless steel. Specifically, the invention relates to such a handpiece wherein at least a selected portion of the handpiece is formed by metal-injection molding.

### BACKGROUND OF THE INVENTION

The present invention is directed generally to improvements in dental devices and more particularly to novel and improved dental handpieces. Dental handpieces are known in the art. An exemplary dental handpiece is shown by way of example, in U.S. Pat. No. 5,716,210, which is hereby incorporated by reference for such disclosure.

The present invention provides improvements in the quality and ease of manufacture of such handpieces. In certain circumstances, the present invention may also allow for more economic fabrication of such handpieces. While the present invention has application to any and all portions of dental handpieces, it has particular application to the head and neck portions of handpieces. It will be understood however, that when the terms “head and neck” or similar words are used, it is referring to all portions of the handpiece, including without limitation, all housing and body portions.

Present conventional methods of fabricating the head and neck assembly of dental handpieces include: (1) machining from one piece of solid metal stock; (2) machining the head and neck separately, then welding or brazing them together, then machine finishing (such as is used in the XGT handpiece available from Dentsply International Inc.); (3) machining the head and neck separately, then attaching the two with a press-fit, threaded connection, or adhesive; and, (4) machining from a metal forging or casting.

In methods 1 and 3, external shapes are limited to what can be economically machined, which typically includes circular cross-sections. Ergonomic, non-circular, shapes would require prohibitively expensive contour milling of the head and neck assembly. While method 4 does afford some design flexibility, these methods require extensive secondary machining to obtain the required precision and surface finish, due at least in part to the limited precision of forging and casting methods.

A need exists therefore, for an economically fabricated dental handpiece that will allow for non-circular cross sections of the fabricated product.

### BRIEF SUMMARY OF THE INVENTION

It is therefore, an object of the invention to provide a dental handpiece.

It is an additional object of the invention to provide a dental handpiece that has at least some non-circular or “profiled” cross sections.

It is a further object of the invention to provide such a handpiece that is efficiently and economically produced.

Using metal injection molding (MIM) it is possible to achieve a unified head and neck assembly for a dental handpiece, with an ergonomic, non-circular shape, substantially without any secondary machining of the exterior contours. Further, MIM produces a “near net shape” part which requires relatively less machining of internal features such as exhaust ports. Further still, it allows these internal features to have shapes that would be expensive or even impossible to achieve with conventional machining.

### BRIEF DESCRIPTION OF THE DRAWINGS

FIG. 1 is a side, perspective view of a handpiece according to the present invention, the handpiece having body, head and neck portions, shown as molded and prior to machining.

FIG. 2 is a perspective view of an alternative embodiment of a head and neck portion of a dental handpiece shown as molded and prior to machining.

FIG. 3 is a side elevational, partially broken away view of a portion of the head and neck portion shown in FIG. 2, shown as molded and prior to machining.

FIG. 4 is a cross-sectional, side elevational view of the head and neck portion of FIG. 2, shown as molded and prior to machining.

FIG. 5 is a rear elevational view of the head and neck portion of FIG. 2, shown as molded and prior to machining.

FIG. 6 is a front elevational view showing a head portion of a handpiece according to the present invention prior to machining.

FIG. 7 shows the head portion of FIG. 6 after partial machining.

FIG. 8 shows a bottom view of a handpiece portion prior to machining.

FIG. 9 shows the portion of FIG. 8 after machining.

FIG. 10 shows another molded portion of a handpiece having a molded area for receiving a fiber optic device and molded pilot holes for other conduits.

FIG. 11 shows the portion of FIG. 10 after machining wherein the pilot holes have been further machined and other conduits have been machined.

FIG. 12 shows a side elevational view of the head portion of FIG. 6.

FIG. 13 shows a side elevational portion of the head of FIG. 7.

### PREFERRED EMBODIMENTS FOR CARRYING OUT THE INVENTION

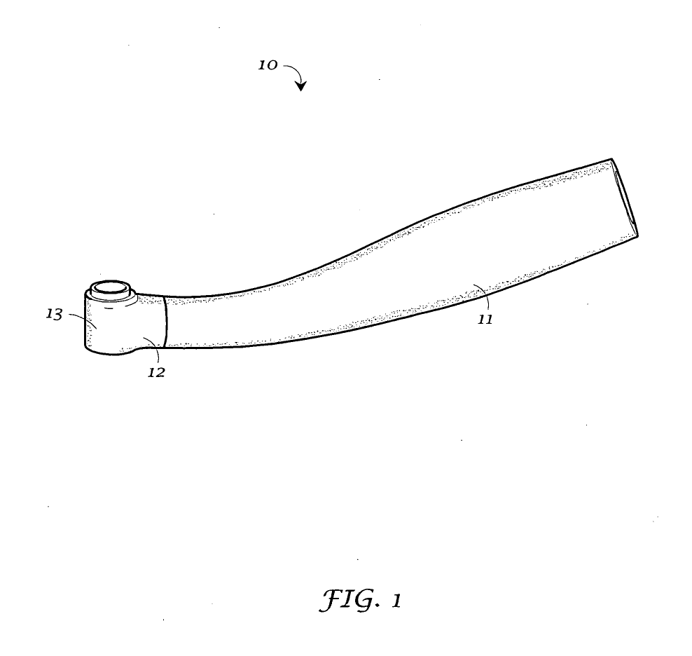

An exemplary dental handpiece is generally designated by the number 10 on the attached drawings. Drawing FIGS. 1-5 show a handpiece as molded and prior to any further machining to refine and further shape the article. In the following discussion, reference may be made to certain areas of the handpiece by given structural names that will only be present after such machining.

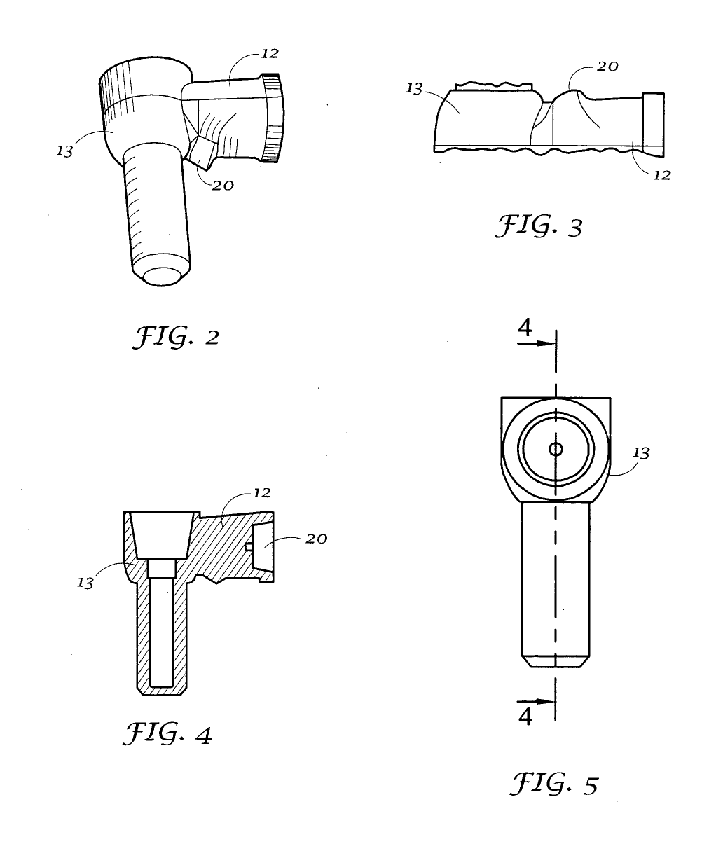

The present invention has application to the manufacture or fabrication of all or any portion of a dental handpiece, including for example, the body 11, neck 12 or head 13 thereof. The invention has particular application to the head 13 and neck 12 portions of dental handpieces 10, because these portions often have cross section with complex profiles, as shown in FIGS. 2-5. For example, the neck 12 depicted in the drawings is provided with a shaped aperture 20 (which may be provided by being molded in place or by being machine into the article by subsequent machining), which is useful with a fiber optic bundle for the transmission of light. As stated above, such contoured shapes can be machined or otherwise formed in conventional handpieces, but with an increase in the time and expense involved if accurate products are to be made.

As is conventional in the dental handpiece art, handpiece 10 may also be provided with internal structures such as fluid passages, exhaust ports and the like (not shown). FIG. 4 shows an example of internal structure, namely internal section 21. Again, such structures have been fabricated in the past using expensive and difficult techniques such as machining. The present invention fabricates products such as those of handpiece 10 using metal injection molding or MIM techniques. MIM is described in for example, U.S. Pat. Nos. 6,241,354 and 6,274,083, which are hereby incorporated by reference for such disclosures. MIM techniques are conventional and need not be described in detail. Conventionally, the MIM material is a mixture of metal particles and a non-metallic binder material. One skilled in the metallurgical arts can specify or select the mixture from a variety of commercially available formulations to achieve the desired properties for the resulting portion of the dental handpiece. The material selected to fabricate the product should be one conventionally employed with dental devices, such as a stainless steel or the like.

While any conventional MIM technique is within the scope of the invention, one such technique includes a metal/binder mixture that is preferably heated in a suitable injection-molding machine and introduced under pressure into a mold, of which the contour corresponds to those of the desired portion of the handpiece, such as head 13 and neck 12.

There are other metal fabrication techniques that may be employed to make a dental handpiece, such as die casting, rubber-plaster casting, investment casting and the like, but it is believed that none currently achieve the combination of metal density, ability to mold stainless steel, reasonable finished cost, and high accuracy afforded by MIM.

Metal injection molding (MIM) makes it possible to achieve a unified head 13 and neck 12 assembly with an ergonomic, non-circular shape, as is shown in the drawings. Employing MIM according to the invention produces a “near net shape” part that requires relatively less machining of internal features such as exhaust ports. MIM allows these internal features to have shapes that would be expensive or even impossible to achieve with conventional machining.

Of course, the use of MIM to fabricate handpiece 10 can be used to prepare any part thereof, including for example, portions having a circular cross section such as in body 11. Similarly, while the invention has application to contoured surfaces or those having a “complex profile” it also has application to any other shape, such as smooth or circular.

According to one embodiment of the invention, the head 13 and neck 12 are of unitary construction. That is, they are fabricated in a singular mold as one contiguous piece. Of course, various parts such as the body 11, neck 12 and head 13 may be formed as individual components that are then joined, and still fall within the scope of the invention. However, it has been found that the unitary head 13 and neck 12 construction has particular and unexpected advantages. The unified head and neck produced by MIM eliminates a joint, which may reduce noise created by relative vibration between the two parts. The unified construction eliminates the potential safety/reliability problem caused by failure of the brazed joint in conventional two-part construction, and it eliminates need for separate fiber-optic ring part.

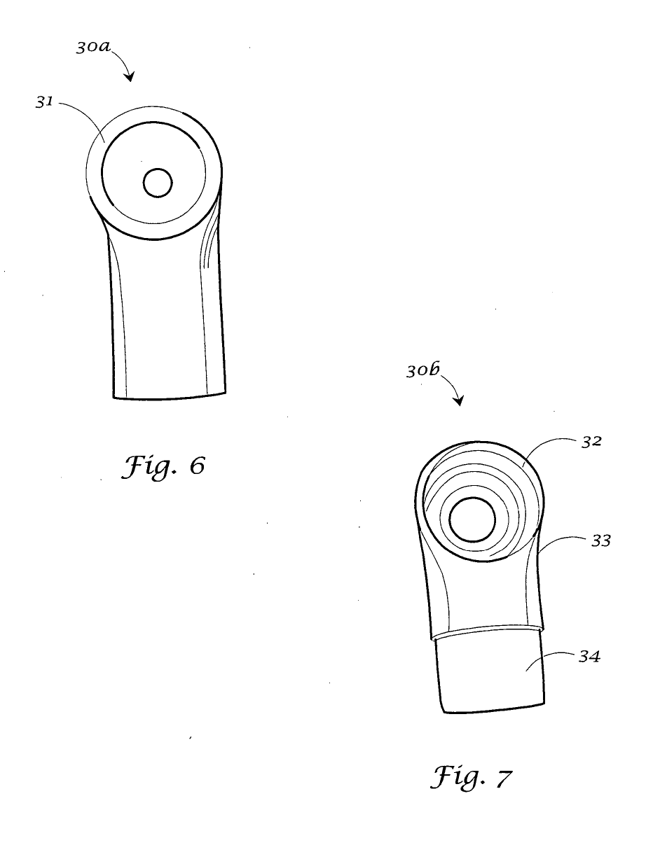

Drawing FIGS. 6-13 show examples of as molded articles (FIGS. 6, 8, 10 and 12) and such articles after having been further machined (FIGS. 7, 9, 11 and 13). By “machined” or “machine” or “machining” or similar language it is understood to mean any conventional technique to shape, reduce, enlarge, configure or otherwise change the profile or dimensions of an article. Examples of such techniques include those conventionally used in metal work, such as lathing, cutting, drilling, electromagnetic discharge, blasting, beading, torching, tooling or the like without limitation.

FIG. 6 shows a handpiece head 30a prior to machining and having a molded and rough dimensioned near net shape for a head cavity 31. FIG. 7 shows the a similar head 30b having a precision machined head cavity 32, an outer surface 33 that has been bead blasted and a rear surface 34 that has been machined for a tight fit into another portion of a handpiece (not shown).

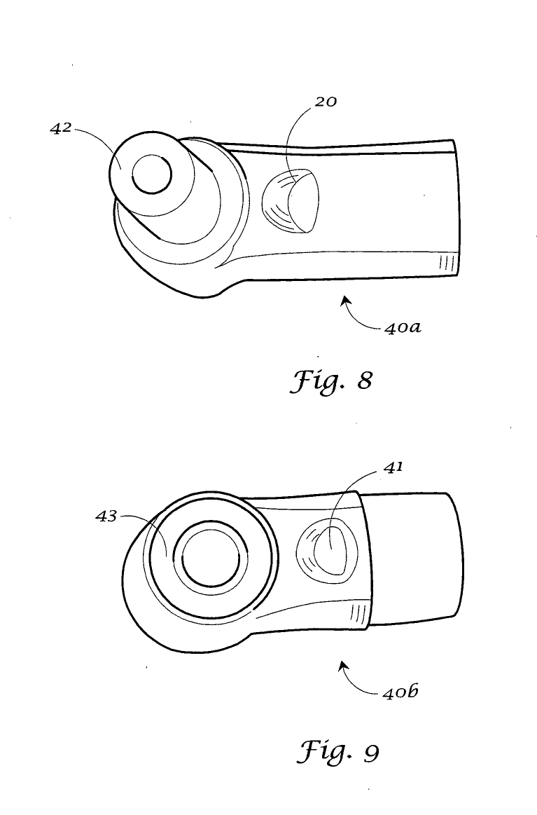

FIG. 8 shows an as-molded handpiece head 40a having a molded area 20 as previously described for receiving another device such as a fiber optic device (not shown). FIG. 9 shows a similar head 40b wherein the same area has been machined to provide conduit 41. Head 40a shows stub 42 used to hold the part during initial machining and head 40b shows the stub machined away or otherwise removed to provide machine head face 43.

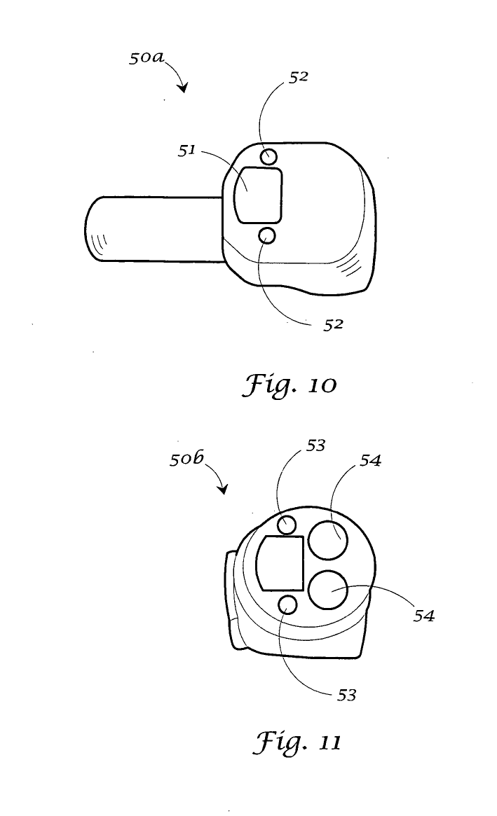

FIG. 10 shows an as-molded head portion 50a of handpiece wherein certain conduits have been at least partially molded. Fiber optic conduit 51 and pilot holes 52 have been provided during the molding procedure according to the invention. FIG. 11 shows a similar head 50b after further machining to refine pilot holes 52 into machined conduits 53. Additional conduits such as drive and exhaust ports 54 may be machined as well.

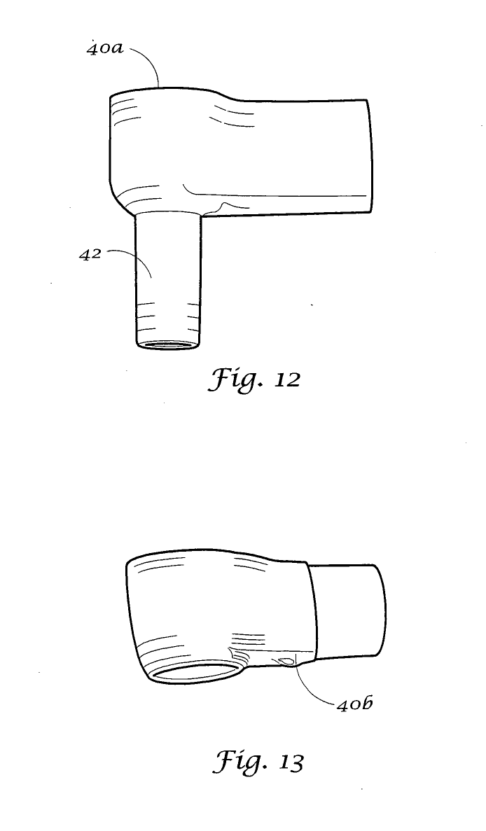

FIGS. 12 and 13 show side views similar to FIGS. 8 and 9 respectively.

While particular embodiments of the invention have been shown and described in detail, it will be obvious to those skilled in the art that changes and modifications of the present invention, in its various aspects, may be made without departing from the invention in its broader aspects, some of which changes and modifications being matters of routine engineering or design, and others being apparent only after study. As such, the scope of the invention should not be limited by the particular embodiment and specific construction described herein but should be defined by the appended claims and equivalents thereof. Accordingly, the aim in the appended claims is to cover all such changes and modifications as fall within the true spirit and scope of the invention.

What is claimed is:

1. A dental handpiece comprising at least one portion having a complex profile, wherein said at least one portion is fabricated by metal injection molding.

2. A dental handpiece as in claim 1, wherein the handpiece has a head and a neck portion, and said at least one portion includes said head portion.

3. A dental handpiece as in claim 2, wherein said at least one portion includes said neck portion.

4. A method of fabricating a dental handpiece having a neck and a head portion, comprising the step of metal injection molding at least a portion of the handpiece.

5. A method as in claim 4, wherein said step of metal injection molding includes metal injection molding the neck of the handpiece.

6. A method as in claim 4, wherein said step of metal injection molding includes metal injection molding the head of the handpiece.

7. A dental handpiece formed by the method of claim 4.

8. A dental handpiece of the type having the component parts of a body, a neck and a head, the improvement comprising forming at least one of the component parts by metal injection molding.

9. A dental handpiece as in claim 8, wherein the metal is stainless steel.

10. A dental handpiece comprising a head and a neck portion, wherein the head and the neck portion are of unitary construction formed by metal injection molding.
